(19) United States
(12) Patent Application Publication
(10) Pub. No.: US 2008/0303187 A1
(43) Pub. Date: Dec. 11, 2008

(54) Imprint Fluid Control

(75) Inventors: Nicholas A. Stacey, Austin, TX (US); Edward Brian Fletcher, Austin, TX (US); Michael N. Miller, Austin, TX (US); Michael P.C. Watts, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 11/965,802

(22) Filed: Dec. 28, 2007

Related U.S. Application Data
(60) Provisional application No. 60/882,654, filed on Dec. 29, 2006.

(51) Int. Cl. B29C 59/00; B44C 1/22

(52) U.S. Cl. 264/293; 428/195.1; 216/41

(57) ABSTRACT

An imprint lithography template with an active area arranged to receive imprinting material during an imprint lithography process and a non-active area adjacent the active area is described. At least a portion of the non-active area is treated to inhibit flow of the imprinting material from the active area to the non-active area during the imprint lithography process.

### CROSS-REFERENCE TO RELATED APPLICATIONS

This application claims priority to U.S. Provisional Patent Application Ser. No. 60/882,654, which is hereby incorporated by reference herein.

### STATEMENT REGARDING FEDERALLY SPONSORED RESEARCH OR DEVELOPMENT

The United States government has a paid-up license in this invention and the right in limited circumstance to require the patent owner to license others on reasonable terms as provided by the terms of 70NANB4H3012 awarded by National Institute of Standards (NIST) ATP Award.

### TECHNICAL FIELD

The field of the invention relates generally to nano-fabrication of structures. More particularly, the present invention is directed to controlling a position of an imprinting material on a substrate.

### BACKGROUND

Nano-fabrication involves the fabrication of very small structures, e.g., having features on the order of nanometers or smaller. One area in which nano-fabrication has had a sizeable impact is in the processing of integrated circuits. As the semiconductor processing industry continues to strive for larger production yields while increasing the circuits per unit area formed on a substrate, nano-fabrication becomes increasingly important. Nano-fabrication provides greater process control while allowing increased reduction of the minimum feature dimension of the structures formed. Other areas of development in which nano-fabrication has been employed include biotechnology, optical technology, mechanical systems and the like.

An exemplary nano-fabrication technique is commonly referred to as imprint lithography. Exemplary imprint lithography processes are described in detail in numerous publications, such as: U.S. Patent Application Publication No. 2004/0065976, filed as U.S. patent application Ser. No. 10/264,960, entitled “Method and a Mold to Arrange Features on a Substrate to Replicate Features having Minimal Dimensional Variability”; U.S. Patent Application Publication No. 2004/0065252, filed as U.S. patent application Ser. No. 10/264,926, entitled “Method of Forming a Layer on a Substrate to Facilitate Fabrication of Metrology Standards”; and U.S. Pat. No. 6,936,194, entitled “Functional Patterning Material for Imprint Lithography Processes,” all of which are assigned to the assignee of the present invention.

The imprint lithography technique disclosed in each of the aforementioned U.S. patent application publications and U.S. patent includes formation of a relief pattern in a polymerizable layer and transferring a pattern corresponding to the relief pattern into an underlying substrate. The substrate may be positioned upon a motion stage to obtain a desired position to facilitate patterning thereof. To that end, a template is employed, spaced-apart from the substrate, with a formable liquid present between the template and the substrate. The liquid is solidified to form a solidified layer that has a pattern recorded therein that is conforming to a shape of the surface of the template in contact with the liquid. The template is then separated from the solidified layer such that the template and the substrate are spaced-apart. The substrate and the solidified layer are then subjected to processes to transfer, into the substrate, a relief image that corresponds to the pattern in the solidified layer.

### BRIEF DESCRIPTION OF THE DRAWINGS

FIG. 1 is a simplified side view of a lithographic system having a template spaced-apart from a substrate;

FIG. 2a is a top down view of the template shown in FIG. 1;

FIG. 2b is a top down view of the template shown in FIG. 1 having a super-repellent surface on a portion of the template, in a first embodiment;

FIG. 2c is a top down view of the template shown in FIG. 1 having a super-repellent surface on a portion of the template, in a second embodiment;

FIG. 2d is a top down view of the template shown in FIG. 1 having a super-repellent surface on a portion of the template, in a third embodiment;

FIG. 3 is a side view of the template shown in FIG. 1;

FIG. 4 is a chart showing ultraviolet transmittance of a multilayer stack before and after exposure to a piranha solution;

FIG. 5 is a side view of the template shown in FIG. 1, having a coating positioned thereon;

FIG. 6 is a perspective of the template shown in FIG. 1, having a coating positioned thereon;

FIG. 7 is a top down view of a substrate shown in FIG. 1, having an extrusion;

FIG. 8 is a top down view of imprint layer having material outside of an active area; and

FIG. 9 is a side view of the template shown in FIG. 1, having a band formed proximate a periphery of a mold.

### DETAILED DESCRIPTION

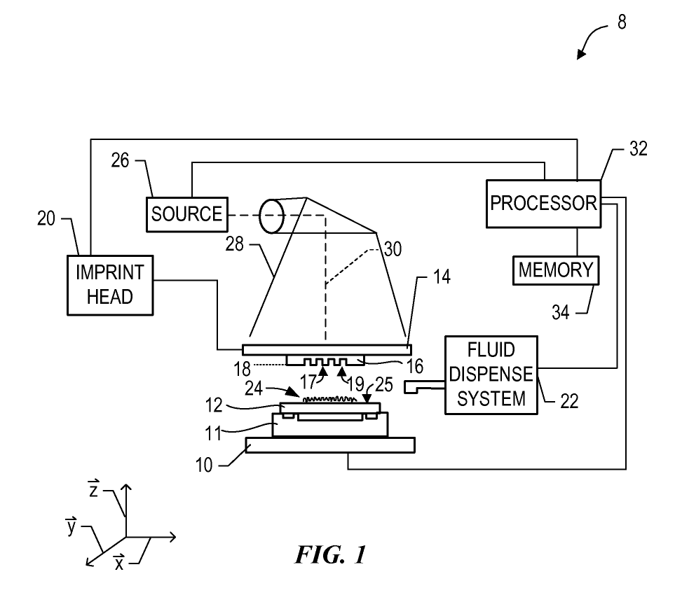

Referring to FIG. 1, a system 8 to form a relief pattern on a substrate 12 includes a stage 10 upon which substrate 12 is supported and a template 14, having a patterning surface 18 thereon. In a further embodiment, substrate 12 may be coupled to a substrate chuck 11, the substrate chuck being any chuck including, but not limited to, vacuum and electromagnetic.

Template 14 and/or mold 16 may be formed from such materials including but not limited to, fused silica, quartz, silicon, organic polymers, siloxane polymers, borosilicate glass, fluorocarbon polymers, metal, and hardened sapphire. As shown, patterning surface 18 includes features defined by a plurality of spaced-apart recesses 17 and protrusions 19, with recessions 17 extending along a direction parallel to protrusions 19 that provide a patterning surface 18 with a shape of a battlement. However, recess 17 and protrusions 19 may correspond to virtually any feature desired, including features to create an integrated circuit and may be as small as a few nanometers. However, in a further embodiment, patterning surface 18 may be substantially smooth and/or planar. Patterning surface 18 may define an original pattern that forms the basis of a pattern to be formed on substrate 12.

Template 14 may be coupled to an imprint head 20 to facilitate movement of template 14, and therefore, mold 16. In a further embodiment, template 14 is coupled to a template chuck (not shown), the template chuck (not shown) being any chuck including, but not limited to, vacuum and electromagnetic. A fluid dispense system 22 is coupled to be selectively placed in fluid communication with substrate 12 so as to deposit polymeric material 24 thereon. Polymeric material 24 may be deposited using any known technique, e.g., drop dispense, spin-coating, dip coating, chemical vapor deposition (CVD), physical vapor deposition (PVD), and the like.

A source 26 of energy 28 is coupled to direct energy 28 along a path 30. Imprint head 20 and stage 10 are configured to arrange mold 16 and substrate 12, respectively, to be in superimposition and disposed in path 30. Either imprint head 20, stage 10, or both vary a distance between mold 16 and substrate 12 to define a desired volume therebetween that is filled by polymeric material 24.

An exemplary source 26 may produce ultraviolet energy. Other energy sources may be employed, such as thermal, electromagnetic and the like. The selection of energy employed to initiate the polymerization of polymeric material 24 is known to one skilled in the art and typically depends on the specific application which is desired.

Referring to FIG. 1, typically, polymeric material 24 is disposed upon substrate 12 before the desired volume is defined between mold 16 and substrate 12. However, polymeric material 24 may fill the volume after the desired volume has been obtained. After the desired volume is filled with polymeric material 24, source 26 produces energy 28, e.g., broadband energy that causes polymeric material 24 to solidify and/or cross-link conforming to the shape of a surface 25 of substrate 12 and patterning surface 18.

The broadband energy can include an actinic component such as, but not limited to, ultraviolet wavelengths, thermal energy, electromagnetic energy, visible light and the like. The actinic component employed is known to one skilled in the art and typically depends on the material from which imprinting layer 12 is formed. Control of this process is regulated by a processor 32 that is in data communication with stage 10, imprint head 20, fluid dispense system 22, source 26, operating on a computer readable program stored in memory 34.

The above-mentioned may be further be employed in imprint lithography processes and systems referred to in U.S. Pat. No. 6,932,934, entitled “Formation of Discontinuous Films During an Imprint Lithography Process”; U.S. Patent Application Publication No. 2004/0124566, filed as U.S. patent application Ser. No. 10/194,991, entitled “Step and Repeat Imprint Lithography Processes”; and U.S. Patent Application Publication No. 2004/0188381, filed as U.S. patent application Ser. No. 10/396,615, entitled “Positive Tone Bi-Layer Imprint Lithography Method”; and U.S. Patent Application Publication No. 2004/0211754, filed as U.S. patent application Ser. No. 10/432,642, entitled “Method of Forming Stepped Structures Employing Imprint Lithography.”

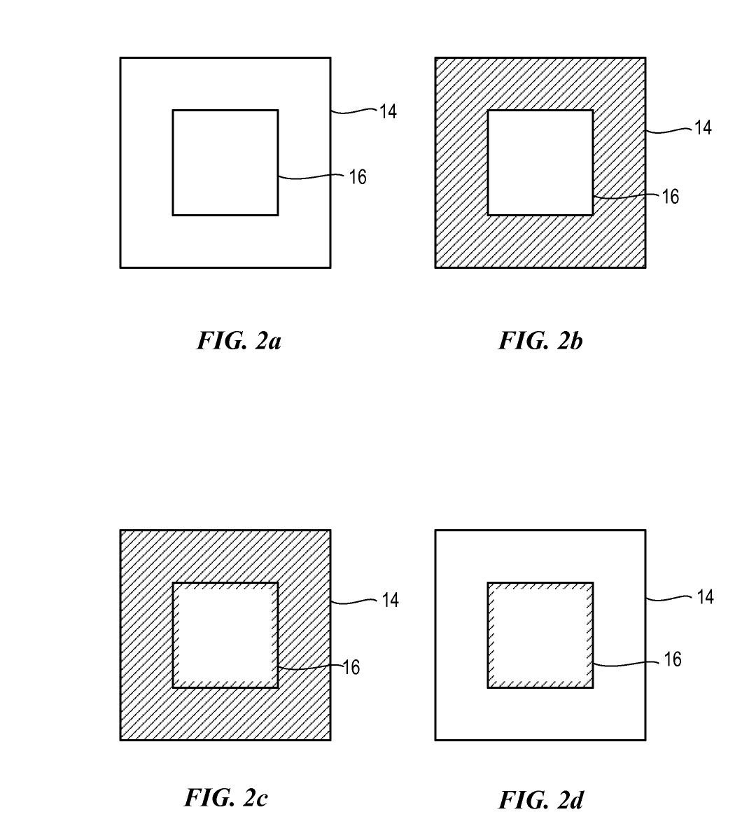

Referring to FIGS. 1 and 2a, to that end, the above-mentioned process may employ low viscosity and low surface tension fluids for polymeric material 24. It may be desired to control polymeric material 24 to an edge of a field to be patterned on substrate 12. Spreading of polymeric material 24 in areas of substrate 12 outside of a desired field may result in loss of “real estate” of substrate 12, i.e., patternable area of substrate 12, undesirable process consistency, and defect generation, all of which are undesirable. As a result, template 14 may be fabricated such that the active area of template 14 may lie on a mesa, i.e., mold 16. The mesa or mold 16 may be defined using lithography and wet etching of the non-active area to a depth of approximately 15 microns. As a result, flow of polymeric fluid 24 may be controlled by a change in capillary forces that accompanies polymeric fluid 24 encountering an edge of mold 16. A description of capillary force is described in U.S. Patent Application Publication No. 2005/0061773, filed as U.S. patent application Ser. No. 10/645,306, entitled “Capillary Imprinting Technique.”

However, the change in capillary pressure may only take effect once polymeric fluid 24 wets an edge or wall of mold 16, i.e., outside of the active area. As a result, poisoning of the cure of polymeric material 24 may be performed to stop polymerization out of the active area. However, this may leave polymeric fluid 24 that accumulates on the edge or wall of mold 16. To that end, it may be desired to minimize, if not prevent, the flow of polymeric fluid 24 to be in superimposition with the non-active area of template 14 and contamination of the non-active area of template 14 with polymeric fluid 24.

In a first embodiment, a super-repellent surface may be employed in the non-active area of template 14, adjacent the active area of the template, such as the surface recessed with respect to mesa 16, as shown in FIG. 2b. A super-repellent surface has a contact angle greater than 90°. In an embodiment of the present invention, at least a portion of the non-active area of template 14 is super-repellent to polymeric fluid 24. In a further embodiment, the super-repellent surface is applied to the edge or wall of mesa 16 and the surface recessed with respect to mesa 16, as shown in FIG. 2c. In still a further embodiment, the super-repellent surface is applied only to the edge of mesa 16, as shown in FIG. 2d.

The super-repellent surfaces of template 14 have a contact angle for polymeric fluid 24 of greater than 90°, as mentioned above. In some cases, the polymeric fluid 24 has a surface tension in the range of 25-30 mN/m. This may represent a low surface tension and as a result, materials such as TEFLON®, having a surface energy of approximately 18 mN/m, are wetted. As a result, to minimize wetting, a low surface energy surface may be desired. This may be achieved by employing a deposited fluorinated self-assembled monolayer (SAM) based on long chain fluorinated silanes or phosphates such as 1H, 1H, 2H, 2H-perfluorooctyltrichlorosilane, 1H, 1H, 2H, 2H-perfluorodecyl phosphate, etc. Such a monomer may have a surface energy of approximately 6 mN/m.

However, employing the above-mentioned surface treatment may result in a contact angle of organic imprinting fluids on the SAM surface only in the 90° range. For super-repellency, higher contact angles may be required. To that end, once a high contact angle is achieved on a given surface, roughening said surface will increase the contact angle thereof. The degree of contact angle enhancement may be a function of the nature of the roughness, with the effectiveness a function of the fractal order of the surface topography, as described in “Super Water- and Oil-Repellent Surfaces Resulting from Fractal Structure” by Shibuichi et al. in J. Colloid Science 1998 Dec. 1; 208(1):287-294.

Both a roughened surface and a highly ordered, low surface energy SAM may be employed to provide a super-repellent surface. In some implementations, a super-repellant surface can be formed on non-active areas of template 14 by depositing nano-roughened surfaces of silica by CVD processing, as described by Ojeda et al. in “Dynamics of Rough Interfaces in Chemical Vapor Deposition: Experiments and a Model for Silica Films,” Phys. Rev. Lett. 2000 Apr. 3; 84(14):3125-3128, and forming (for instance, vapor depositing) a SAM on the roughened surface. The SAM may include, for example, 1H, 1H, 2H, 2H-perfluorooctyltrichlorosilane. In some cases, aluminum is deposited on a nano-roughened silica, and a SAM is formed on the aluminum. Forming the SAM may include, for example, applying 1H, 1H, 2H, 2H-perfluorodecyl phosphate in a solution process. In other cases, aluminum deposited on a nano-roughened silica can be anodically oxidized to create a fractal oxide surface. A fluorinated SAM including, for example, 1H, 1H, 2H, 2H-perfluorodecyl phosphate can be formed on the oxide surface. In some implementations, silica is deposited (for example, by CVD) on the anodically oxidized surface, and a SAM is formed on the silica. The SAM can include, for example, 1H, 1H, 2H, 2H-perfluorooctyltrichlorosilane.

Other fluorinated SAMs and other low energy surfaces may be employed. Similarly, there are numerous ways to achieve the surface roughening on the desired dimensions (tens of nanometers). Furthermore, the deposition of silica followed by SAM may be utilized, since the silica and possibly the SAM can be substantially chemically inert to cleaning in harsh environment such as piranha, etc. that are used to clean templates such as, for example, fused silica templates.

Table 1 lists contact angle measurements of water and monomer on perfluoro silane and perfluoro phosphate SAMs formed on anodized aluminum.

TABLE 1

| | | Polymerizable |
|---|---|---|
| | DI Water | composition |
| Fluorinated silane SAM | 124° | 83° |
| (molecular vapor deposition) | | |
| Fluorinated phosphate SAM | 140° | 84° |
| (wet process) | | |

The polymerizable composition is a mixture of, for example, i) approximately 47 g of isobornyl acrylate, ii) approximately 25 g of n-hexyl acrylate, iii) approximately 25 g of ethylene glycol acrylate, iv) approximately 0.5 g of ZONYL® FSO-100 surfactant (available from Sigma-Aldrich Co., St. Louis, Mo.), and v) approximately 3 g of DAROCUR® initiator (available from Ciba, Basel, Switzerland).

In an example, the fluorinated silane used for non-active area SAM treatments provide water contact angles of 110°-115° and polymerizable composition contact angles of 61°-66° on a smooth quartz surface.

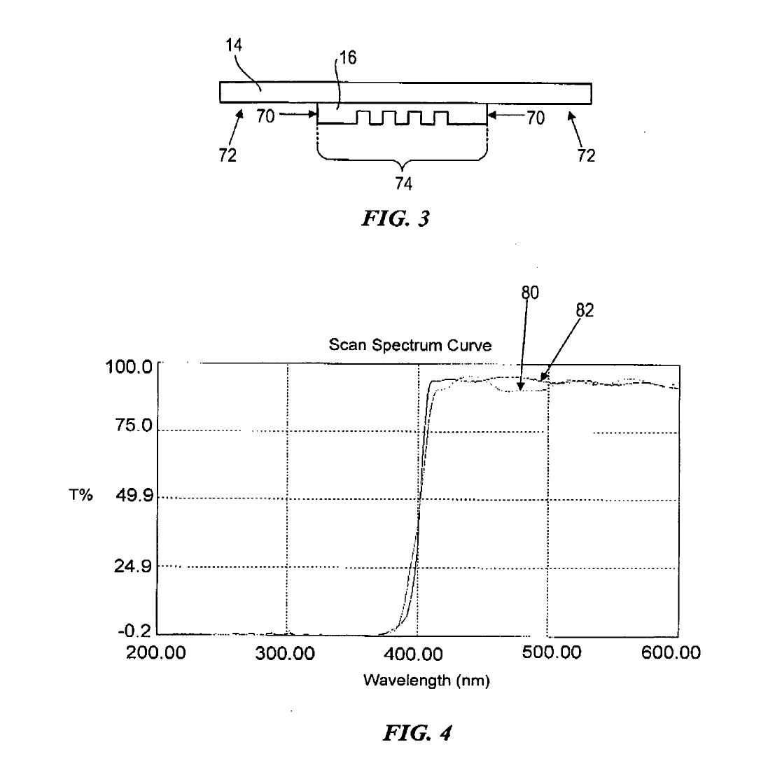

Referring to FIG. 3, in a further embodiment, an approach for adhering a low surface energy SAM to mesa walls 70 of mold (i.e., mesa) 16 and recessed (e.g., etched back) regions 72 of template 14 is herein described. More specifically, template 14 may be altered. A SAM process that employs the altered template 14 is described more fully below.

In the further embodiment, template 14 may include quartz with a metal or metal oxide coating on mesa walls 70 and/or recessed area 72, with the coating substantially absent from active area 74. A SAM system with a fluorinated phosphate produces a highly ordered low surface energy SAM substantially only on the metal or metal oxide surface. In an example, active area 74 may be in superimposition with mold 16.

SAMs can be formed from alkyl phosphates and/or phosphonates on metal or metal oxide surfaces under conditions that do not result in well ordered SAMs on silica. To that end, transition metal oxides may interact strongly with phosphates or phosphonates to form highly stable interfacial bonds. In contrast, the affinity of phosphate for Si(IV) is much lower, as described in “Alkyl Phosphate Monolayers, Self-Assembled from Aqueous Solution onto Metal Oxide Surfaces” by Hofer et al. in Langmuir 2001(17):4014-4020.

The SAM may be formed on a metal or metal oxide coating that is transmissive to ultraviolet (UV) light, or may be applied to a UV blocking dielectric film stack or other type of UV block coating as long as an appropriate metal or metal oxide surface is available on which the SAM can be formed.

The metal or metal oxide coating may be compatible with a process of cleaning template 14, thus facilitating reapplication of the SAM after each template reclaim. For example, zirconium oxide, niobium oxide, and tantalum oxide have good corrosion resistance to sulfuric acid and hydrogen peroxide. As a result of the chemical resistance obtained with certain metal and metal oxide coatings, a selective nature of the SAM deposition process may be as permanent as the coated surface.

In a further embodiment, rough metal or metal oxide surfaces such as anodized aluminum may be employed to increase the effective hydrophobicity of the SAM. In an example, higher advancing contact angles with alkanephosphate SAMs on rough titanium metal versus smooth titanium surfaces is described in “Self Assembled Monolayers of Alkanephosphates on Titanium Oxide Surfaces” by Tosatti et al. in European Cells and Materials 2001(1:1): 9-10.

Referring to FIG. 3, described below is an implementation of the present invention. Aqueous and non-aqueous (solvent) systems may be used for SAM formation. Fluorinated phosphate (mono-[2-(perfluorooctyl)ethyl]phosphate) (available from SynQuest Laboratories, Inc., Alachua, Florida) is soluble in isopropyl alcohol, and can be converted to a water-soluble ammonium salt. In each case, 0.077 g of fluorinated phosphate is dissolved in 100 ml of solvent (IPA or water). Template 14 may be cleaned with a piranha solution or UV-ozone process to remove organic contamination on the surface. Template 14 (available from Deposition Sciences, Inc. of Santa Rosa, California) includes quartz and/or aluminum, and may include a UV blocking multilayer film stack with zirconia (outer layer) and silica. In an example, after cleaning to remove surface residue or contamination, quartz template 14 has a water contact angle of <10°. Template 14 is submerged in a fluorinated phosphate SAM solution, after which template 14 and then rinsed with the same solvent employed to dissolve the phosphate, and subsequently blown dry with nitrogen. A Kruss goniometer may be employed to measure contact angles.

Contact angle data is shown below in Table 2 for the aqueous perfluoro phosphate SAM system and the polymerizable composition described above.

TABLE 2

| | | Polymerizable |
|---|---|---|
| Template | Water | composition |
| Quartz (smooth) | <10° | 27° |
| Zirconia over silica (smooth) | 92° | 65° |

As seen in Table 2, a high monomer contact angle was obtained on zirconia, and the hydrophilic nature of quartz cleaned with piranha solution was maintained.

The contact angle of the polymerizable composition on zirconia is comparable to that of perfluoro silane SAM treatment on quartz. The perfluoro silane system inhibits extrusions and extends process longevity when applied to mesa walls 70.

Contact angle data is shown below in Table 3 for selective aqueous perfluoro phosphate SAM formation on aluminum. The impact of surface roughness on contact angle is apparent in Table 3.

TABLE 3

| | | Polymerizable |
|---|---|---|
| Template | Water | composition |
| Quartz (smooth) | 28° | not measured |
| Aluminum (rough) | 140° | 84° |

Contact angle data is shown below in Table 4 for a non-aqueous SAM system (IPA as solvent).

TABLE 4

| | | Polymerizable |
|---|---|---|
| Template | Water | composition |
| Quartz (smooth) | 28° | 41° |
| Zirconia over silica (smooth) | 107° | 67° |

Although the water contact angle on quartz may show contamination or modification, selective SAM formation may be exemplified by these results. Process variables such as phosphate concentration, soak time, and rinsing procedures may lower the contact angle on quartz without adversely affecting the SAM on zirconia.

In another example, a multilayer film stack (zirconia and silica) may be subjected to six hours of piranha (2:1 sulfuric acid to hydrogen peroxide) at temperatures in the range of 120° C. to 140° C. The stack was then rinsed with DI water, dried with nitrogen, and dipped in an aqueous perfluoro phosphate system. No delamination or pitting of the coating resulted from the piranha treatment.

Referring to FIG. 4, the UV transmittance of the multilayer film was measured before and after the six hour piranha exposure. Line 80 refers to post piranha exposure, while line 82 refers to pre-exposure. The UV blocking attribute does not appear to be affected in this case.

Contact angle data is shown below in Table 5 for (tridecafluoro-1,1,2,2-tetrahydrooctyl)trichlorosilane after dip coating or vapor deposition.

TABLE 5

| | | Polymerizable |
|---|---|---|
| Template | Water | composition |
| Quartz | 65° | not measured |
| Aluminum (rough) | not measured | 83° |

A piranha cleaned quartz template is shown to have a water contact angle of <10° and a contact angle of about 26°-30° with the polymerizable composition.

Referring to FIG. 3, an embodiment of the invention includes a method to reduce wetting of mesa walls 70 and recessed region 72 of template 14 by coating the mesa walls and the recessed region with a low surface energy SAM. The selective application of the SAM may be obtained through having two exposed surfaces, one being silica and the other a metal or metal oxide capable of forming strong phosphate coordination complexes to generate the SAM. Thus, a quartz template with off-mesa metal oxide coatings can be treated in a bulk solution of the SAM, leaving a non-wetting SAM surface only on the metal or metal oxide coated region.

In some embodiments, the templates may be chemically reclaimed through harsh cleaning solutions such as piranha (sulfuric acid, peroxide mixture) without degrading the metal or metal oxide coated region. In an example, the outer layer of the coated region is zirconia, which may have desired survivability to repeated exposures to piranha solution.

Fluorinated SAM coatings deposited on the off-mesa regions, such as mesa walls 70 and recessed area 72, of template 14 can work to minimize, if not prevent, edge-thickening and extend the life of the patterning process, mentioned above with respect to FIG. 1. One technique for achieving off-mesa SAM coatings relies on the eye-hand coordination of an operator to manipulate a micropipette around the perimeter of the template mesa, i.e., mold 16, while dispensing the SAM system. However, this method may create non-uniform SAM coverage which may result in regions having lower hydrophobicity, or it may result in the formation of SAM on active area 74 of template 14 which can adversely affect spreading and filling of polymeric material 24, shown in FIG. 1. Another technique requires active area 74 be physically masked each time the SAM is deposited. Due to the harsh nature of the reclaim process, the masking is performed following each reclaim.

The metal oxide coating may be UV transmissive, however, in a further embodiment, it may be desired to selectively combine binding metal oxide surface with a UV blocking coating. By depositing a UV blocking layer onto the perimeter region of the mesa's active area, defects may be minimized, if not prevented. The defects may include, but are not limited to, extrusions from drop on demand dispense technology as well as unwanted curing for spin-on monomer. Curing outside of active area 74 when constructing template replicas that are made by printing into a UV curable hybrid sol-gel such as Ormoclad may also be minimized, if not prevented. In a further embodiment, the coating may be acid resistant and capable of surviving repeated cleanings.

UV blocking coatings may be dielectric layered coatings as well as inert and protected metal coatings. Many materials may be employed to reflect and/or absorb UV light, however, the coating may be deposited during the construction of template 14 and may survive future use including repeated cleanings. “Off the mesa” treatments that involve deposition of material to the mesa perimeter following cleaning require reapplication after additional cleaning processes.

The dielectric coatings may be a multilayer structure of two materials with different indices of refraction. The outside layer is often silica, however, other metal oxides may be employed as the outer surface of the structure. In a further embodiment, protected aluminum and other metals may be employed. The metal is coated to a sufficient thickness to reflect and/or absorb light, then overcoated with a metal oxide. Such an overcoat will enhance the coating's overall resistance to cleaning solutions used to clean template 14. In a further embodiment, template 14 may be coated with an inert metal such as niobium, which has superior resistance to sulfuric acid.

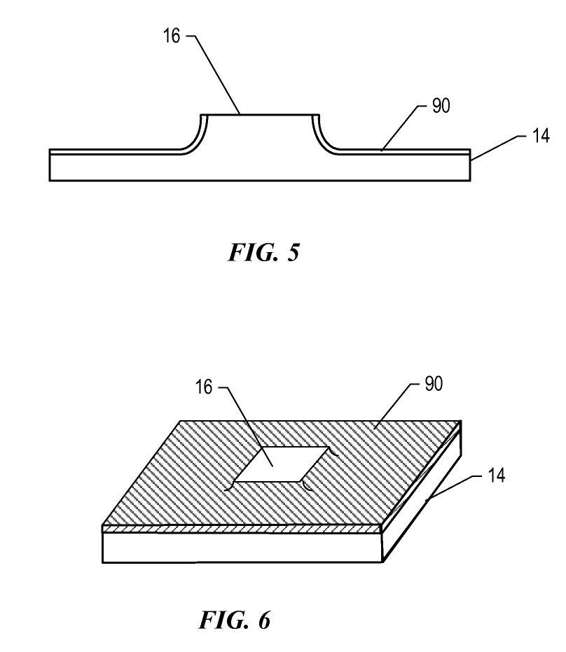

Referring FIGS. 5 and 6, shown is coating 90 on template 14. Coating 90 may be deposited with the protective photoresist intact on the active area. The photoresist would remain following the buffered oxide etch of template 14 outside of active area 74, shown in FIG. 3. Following UV-block coating, the photoresist and remaining chrome would be removed as usual.

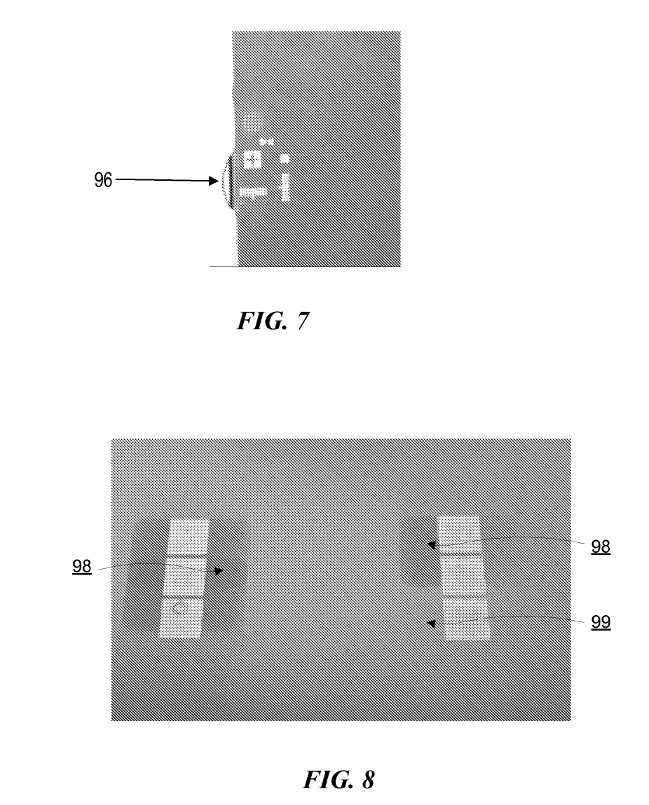

To that end, one of the benefits of the UV blocking layer, such as coating 90, is to minimize, if not prevent, extrusion 96 that can form at the edge of imprints, as shown in FIG. 7. Extrusion 96 may be minimized, if not prevented, by curing through that region on template 14. These extrusions can cause detrimental effects during coating of additional layers over imprints. In an example, comets may be produced that originate at the extrusion site and extend to the edge of substrate 12, resulting in localized thickness differences in material that may cause undesirable defects during subsequent etch steps.

Furthermore, as a result of spin coating a layer on substrate 12, any UV light that exposes polymeric material 24 outside of active area 74 may result in unwanted curing in these areas. Subsequent imprints in these locations are being imprinted over partially cured material, leading to different thicknesses as well as impacting the overall resolution of imprint features. An example of unwanted curing outside of the active area for a spin coated monomer film is shown as dark regions 98 in FIG. 8. The UV blocking layer solves the problem by eliminating exposure of these regions to UV light, thus inhibiting curing in region 99.

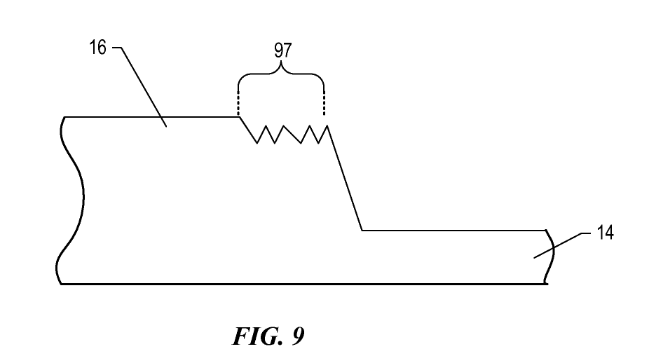

Referring to FIG. 9, in still a further embodiment, a self-aligned band 97 of rough non-wetting surface around a periphery of mesa 16 is shown. Band 97 includes a strip approximately 1-10 μm in width of points at least 100 nm high recessed from the surface of template 14 by about 100 nm to about 10 μm. These points are treated to form a non wetting surface.

Band 97 may be formed by:
1. writing a border about 1-10 μm wide of chrome spots about 50-500 nm in size (about 100 nm-2 μm in pitch) around the edge of template 14 during fine feature patterning either by electron beam or laser pulse generator, and etching these down to the standard tooth depth;
2. coating with resist and mesa exposed;
3. making a second low exposure over the border region so that after developing, a self-aligned thinner resist layer is created over the border; this may also be formed via a 2 tier imprint; alternatively a second mesa patterning could be used after mesa etching to define the border;
4. wet or dry etching the mesa—if employing wet etching, the border can be surrounded by a wide chrome border similar in size to the wet etch depth to ensure adequate adhesion during wet mesa etching;
5. dry etching back the mesa resist to clear the border region;
6. wetting/drying the quartz and/or chrome etch in combination to etch the border and undercut the chrome spots to form a set of slightly recessed points; the undercutting dry etch would create deep points; striping the chrome such that disks are not scattered everywhere; wet etching or dry etching to recess the points back from the template surface;
7. dicing and polishing;
8. optionally treating with non wetting layer;
9. stripping remaining resist and chrome; and
10. optionally treating with non wetting layer.

In a further embodiment, the aforementioned process may be employed by creating a mesa prior to fine feature patterning. As a result, extra process steps may be needed to pattern the border spots.

The embodiments of the present invention described above are exemplary. Many changes and modifications may be made to the disclosure recited above, while remaining within the scope of the invention. Therefore, the scope of the invention should not be limited by the above description, but instead should be determined with reference to the appended claims along with their full scope of equivalent.

1. An imprint lithography template comprising:
an active area arranged to receive imprinting material during an imprint lithography process; and
a non-active area adjacent the active area,
wherein at least a portion of the non-active area is treated to inhibit flow of the imprinting material from the active area to the non-active area during the imprint lithography process.

2. The imprint lithography template of claim 1, wherein the active area comprises a mesa.

3. The imprint lithography template of claim 2, wherein the treated area comprises a surface recessed with respect to the mesa.

4. The imprint lithography template of claim 2, wherein the treated area comprises a roughened, recessed border on the mesa.

5. The imprint lithography template of claim 2, wherein the treated area comprises a wall of the mesa.

6. The imprint lithography template of claim 1, wherein a contact angle of a polymerizable material on the treated area is at least about 90°.

7. The imprint lithography template of claim 1, wherein the treated area includes a fluorinated self-assembled monolayer bonded to the surface of the non-active area.

8. The imprint lithography template of claim 1, wherein the treated area includes a fluorinated self-assembled monolayer bonded to a roughened surface.

9. The imprint lithography template of claim 1, wherein the treated area includes a fluorinated self-assembled monolayer bonded to a metal or metal oxide coating.

10. The imprint lithography template of claim 1, wherein the treated area includes a UV blocking layer.

11. A method of treating an imprint lithography template, comprising:
providing an imprint lithography template with an active area and a non-active area, wherein the active area comprises a mesa; and
treating at least a portion of the non-active area to inhibit flow of an imprinting material from the active area to the non-active area during an imprint lithography process.

12. The method of claim 11, wherein the non-active area comprises a wall of the mesa and a recessed surface with respect to the mesa.

13. The method of claim 11, wherein treating comprises forming a metal or metal oxide layer on the portion of the non-active area.

14. The method of claim 11, wherein treating comprises roughening the portion of the non-active area.

15. The method of claim 11, wherein treating comprises forming a fluorinated self-assembled monolayer on the portion of the non-active area.

16. The method of claim 15, wherein treating comprises forming the fluorinated self-assembled monolayer by dipping the template in an aqueous perfluoro phosphate system.

17. The method of claim 11, wherein treating comprises forming a silica layer on the portion of the non-active area, and forming a fluorinated self-assembled monolayer on the silica layer.

18. The method of claim 11, wherein treating comprises forming a zirconia layer on the portion of the non-active area, and forming a fluorinated self-assembled monolayer on the zirconia layer.

19. The method of claim 11, further comprising forming a roughened, recessed border on the mesa.

20. The method of claim 19, further comprising forming a fluorinated self-assembled monolayer on the roughened, recessed border.

21. A method of treating an imprint lithography template, comprising:
(a) depositing a border about 1-10 μm wide of chrome spots about 50-500 nm in diameter around an edge of a mesa on the template;
(b) etching the border;
(c) coating the template with resist;
(d) exposing the mesa;
(e) exposing the border or patterning the mesa to form a self-aligned resist layer over the border,
(f) etching the mesa; and
(g) etching the border to form recessed points in the border.

22. The method of claim 21, further comprising treating the border with a fluorinated self-assembled monolayer.

23. An imprint lithography template comprising;
an active area arranged to receive imprinting material during an imprint lithography process; and
a non-active area adjacent the active area,
wherein a surface of the template in the non-active area comprises anodized aluminum adhered to the surface and a fluorinated phosphate layer bonded to the anodized aluminum.

24. The imprint lithography template of claim 23, wherein the fluorinated phosphate is an alkyl phosphate.

25. The imprint lithography template of claim 23, wherein a contact angle of deionized water on the non-active area is greater than about 120°.

26. A method of treating an imprint lithography template, comprising:
providing an imprint lithography template with an active area and a non-active area, wherein the active area comprises a mesa and the non-active area is proximate the mesa;
depositing aluminum the non-active area;
anodizing the aluminum on the non-active area; and
depositing a fluorinated phosphate on the anodized aluminum.

27. A method of treating an imprint lithography template, comprising:
providing a silicon-dioxide imprint lithography template with an active area and a non-active area, wherein the active area comprises a mesa, and the non-active area is proximate the mesa;
protecting the mesa such that the surface of the mesa is not exposed to the atmosphere;
depositing a metal or metal oxide on the non-active area;
deprotecting the mesa to expose the surface of the mesa;
wetting the template with a fluorinated phosphate solution;
forming a self-assembled monolayer of the fluorinated phosphate only on the non-active area of the template; and
rinsing the template to remove excess fluorinated solution from the silicon dioxide surface of the active area of the template.

28. The method of claim 27, wherein protecting the mesa comprises masking the mesa.

29. The method of claim 27, wherein the metal is aluminum.

30. The method of claim 27, wherein the metal oxide is a transition metal oxide.

31. The method of claim 27, wherein the solution is a non-aqueous solution.

32. The method of claim 27, wherein wetting comprises dip coating.

33. The method of claim 27, further comprising cleaning the template in piranha solution, wherein the self-assembled monolayer remains substantially intact during the cleaning.

34. The method of claim 27, wherein a contact angle of deionized water on the non-active area is at least about 90°.
